(19) United States
(12) Patent Application Publication
(10) Pub. No.: US 2011/0252545 A1
(43) Pub. Date: Oct. 20, 2011

(54) Lacrosse helmet cover

(76) Inventors: Stacey Irrgang, Reisterstown, MD (US); Lisa Hapney, Reisterstown, MD (US); Bennett Cummings, Finksburg, MD (US)

(21) Appl. No.: 12/930,678

(22) Filed: Jan. 13, 2011

Related U.S. Application Data
(60) Provisional application No. 61/294,734, filed on Jan. 13, 2010.

(51) Int. Cl. A42B 3/04; B32B 3/06; A42B 3/18; A42B 3/12; A63B 71/10

(52) U.S. Cl. 2/414; 428/44

(57) ABSTRACT

A cover for a lacrosse helmet made from four elastic fabric panels is disclosed that closely conforms to the shape of a lacrosse helmet and includes a center panel that is cut into the shape of a polygon and has a front side a rear side and two lateral sides, a pair of lateral panels and a rear panel that is cut into the shape of a segment of a circle that includes a straight side and an arcuate side. The rear side of the center panel is attacked to the middle of the arcuate side of the rear panel. The lateral panels are shaped to cover the portion of the helmet that is opposite the ears and include straps that fasten to a chin guard of a conventional lacrosse helmet. The straight side of the rear panel and a front side of the central panel are gathered together and sewn to allow these sections to stretch. The helmet cover further includes openings in the rear panel to allow access to snap-on posts provided on the helmet.

### BACKGROUND OF THE INVENTION

This application claims the benefit of the filing date of U.S. Application No. 61/294,734 filed on Jan. 13, 2010.

The present invention relates to an improved covering for a lacrosse helmet. There are numerous coverings for helmets disclosed in the prior art. The objective for providing a covering for a helmet may be for decorative purposes, to provide camouflage, to enhance safety, and to provide waterproofing to name just a few. Helmet covers are subject to numerous utility and design patents, a number of which are briefly discussed herein.

U.S. Pat. No. 6,061,836 discloses an elastic fabric cover for use with a conventional hard hat that does not have a section that extends down to cover the temporal region of the skull, and more particularly the lower temporal section opposite the ear. The elastic cover disclosed will stretch to fit over the helmet and contracts to fit the contour of a hard hat structure. The device includes a stiffened segment located on the main body for the purposes of displaying visual media or a logo. The purpose of the invention was to make the helmet cover any more attractive and avoid some of the problems with placing images onto a fabric to be placed on the hard hat.

U.S. Pat. No. 6,848,122 B1, discloses a removable helmet cover that includes a flexible dome-shaped soft cloth exterior surface disposed on top of a flexible dome-shaped soft cloth interior liner.

U.S. Pat. No. 6,256,799 B1, generally discloses a flexible cover with an outer periphery and an elastic material that is disposed near the outer periphery

U.S. Pat. No. 4,345,336 discloses a stretchable fabric cover which slips over a helmet shell and snugly fits thereon.

U.S. Pat. No. D362,085 discloses a design for a helmet cover.

U.S. Pat. No. 6,711,752 discloses a cover for protecting a helmet, including a drawstring and is designed to entirely enclose a helmet.

U.S. Pat. No. 3,445,860 discloses a helmet cover with an outer periphery and a fastener disposed near the outer periphery.

U.S. Pat. No. 3,582,990 discloses a ballistic cover for a helmet including an outer periphery having loops which receive a pre-tensioned cord that retains the cover on the helmet.

U.S. Pat. No. 4,937,888 discloses a padded cover for partially covering a helmet and includes an outer periphery with flexible tabs disposed near the outer periphery. However the helmet cover does not cover the helmet entirely nor is it designed to closely conform to a brim section.

As demonstrated by the prior art, there continues to be a need for improved and alternative, helmet covers, which are removable and that allow the individual to distinguish himself or herself from others. Helmet covers have been developed for applications including biking, skiing, hockey, baseball, motorcycle riding, horseback riding, construction, football and the military and each type of helmet used for these activities is unique. Helmets used for football, lacrosse, and hockey and, in some circumstances, baseball are designed to cover most of the head, including lateral extensions that extend over the ears and down to or near the lower mandible. These helmets also usually include an integrated protective a face mask that is attached to the helmet at areas surrounding the opening for the player's face.

In response to the demand to be able to distinguish players on teams, covers have been developed for football helmets and are sold commercially. Manufacturers of these football helmet covers include Champion Sports, Adams and Don Alleson. The commercially available covers, illustrated in FIGS. 1-4, are designed and marketed to be worn during practice or scrimmaging and the covers make it easier to distinguish particular players and teams of players. Helmet covers are helpful to both the players and the coaches for these purposes.

Prior art commercially available football helmet covers are made from nylon or spandex and generally have a circular opening to receive the helmet. The covers are generally a semispherical in shape. The covers have a continuous elastic band or reinforced region that is sewn around the perimeter of the opening. These football helmet covers are designed to engage the helmet whereby the opening is stretched past a position that has the greatest circumference on the helmet. If the cover is placed on the helmet so that it is stretched past an arc segment on the helmet that has the greatest distance, the elastic will keep the cover in place. The prior art football helmet covers are made from three panels to form a semispherical shape. This semispherical shape will generally cover a large portion of the exterior shell of the helmet but does not cover the portion of the helmet that protects the cheeks, or the areas that are opposite the temporal region of the cranium and, more particularly, near the ear. The commercially available football helmet covers leave uncovered some of the various fittings used to attach the chinstrap and typically comprise a single solid color.

As illustrated in FIG. 1-4, the commercially available football helmet covers do not fit the helmet well and do not completely cover the exterior shell. While the commercially available football helmet covers may be satisfactory for scrimmages and temporary use, because the covers do not substantially completely cover the exterior surface of the helmet, the helmets do not have a smooth and professional finished appearance. As such, players do not wear such football helmet covers in competitive games, regardless of the fact that providing a unique helmet color may improve a player's ability to rapidity identify both opposing players and players on one's own team. The manufacturers of football helmet covers market and sell the products for use in connection with scrimmaging and they are not intended to be worn during game conditions. While it may be possible to pull the cover past the rear lip of the helmet as illustrated in FIG. 4, the covers are not designed to fit the helmet in this manner and, the presence of excess material that extends past the lip of the helmet may interfere with the fit of the helmet. The side opposite the rear edge of the helmet cover is intended to abut the top of the face mask. As a result, the opening of the cover generally extends in an arc that extends from the top of the facemask, near the ear opening to the rear lip of the helmet and returns on the opposite side. As such, the cover is not designed to cover the helmet at the lateral sides adjacent to the face mask below the ear hole.

The design of football helmet covers allows a player will be able to easily remove the helmet without removing the cover. In this regard, the prior art helmet cover designs for football will generally not cover the hardware that is necessary to attach and secure the chinstraps. As such, a player can first secure the chinstrap in place and then may attempt to further pull the cover down around the edges of the helmet. However, this procedure is cumbersome and often the player must seek assistance to secure the cover around the rear edges. If the cover is put on the helmet before the helmet is put on and secured with the chinstraps, care must be exercised to avoid covering the chinstrap hardware snap posts.

The hardware to secure chinstraps is provided at standard locations which depend on the attachment scheme, which may be a two point or four point system. The two point attachment system use two snap posts that extend from the helmet near the ear openings. The four point system, which has now been widely adopted by most helmet manufactures, uses two snaps that are located on the front of the of the helmet at a location at approximately forehead level, near the location where the face mask or cage is attached to the helmet and two snaps that are located behind the ear opening along the rear edge of the opening of the helmet. The chin straps that extend from the front of the helmet extend into the face mask to the cup that receives the players chin. Alternative chin straps attachment arrangements are also referred to as either “four point low” or “four point high.” Different four point chinstrap designs for athletic helmets are disclosed in U.S. Pat. No. 3,166,761 dated Jan. 26, 1965; and U.S. Pat. No. 4,646,368, dated Mar. 3, 1987, which are incorporated by reference herein. These references disclose an arrangement wherein a first strap is attached to the helmet at a lower part of each of the ear protecting portions of the helmet, and a second strap is attached to the helmet at a higher part of each of the ear protecting portions of the helmet. The first and second straps cross over each other in two places to form a chin cup. Virtually all modern lacrosse helmets that are presently manufactured use a four point high system.

As discussed above, commercially available helmet covers for football helmets have a number of disadvantages and, as discussed herein, are not suitable for use with lacrosse helmets. Comparable with football and hockey, men's lacrosse involves high-mass, high-velocity, body-to-body collisions and low-mass, high-velocity, object-to-body impacts that are inherent to the sport and can cause serious, life-threatening injuries. Like football helmets, lacrosse helmets cover substantially the entire head and include a face mask. As discussed above, the covers for football are designed to fit only partway around the football helmet and do not cover the lower section opposite the temporal portion of the skull. In order to allow for access to the chinstrap hardware, they do not cover large portions of the exterior shell of the helmet. Further, conventional football helmet covers are not shaped to accommodate the short brim that extends from lacrosse helmets from a location opposite the forehead. In addition, the shape of a lacrosse helmets are generally different than football helmets. Lacrosse helmets also include a throat or lower jaw protective element that extends from a position below the players ears and which extends forward to roughly conform to the contour of the lower jaw.

In view of the different requirements and features, the design of lacrosse helmets differs from the designs of football and ice hockey helmets. Such helmets also have some difference within the sport of lacrosse itself. Unlike football and hockey helmets, some lacrosse helmet models (eg, Brine, Riddell, Cascade, and Warrior) have small brims. In these models, there is also a chin guard that is attached to the helmet by metal screws. Other lacrosse helmets have (Cascade, Gait) a chin guard that is integral to the helmet. See Lacrosse Equipment and Cervical Spinal Cord Space During Immobilization: Preliminary Analysis, Michael Higgins, PhD, PT, ATC, CSCS,* Ryan T. Tierney, PhD, ATC,^{†} Jeffrey B. Driban, PhD, ATC, CSCS,^{†}. Steven Edell, DO,^{‡}, and Randall Watkins, ATC, J Athl Train. 2010 January-February; 45(1): 39-43. Lacrosse helmets include a face mask that serves to protect the player from flying balls, sticks and as well as from impacts from other players. The face masks used for lacrosse are generally made from a stiff wire or a metal framework that tries to maximize visibility but still provide adequate protection to the players face.

While some teams or clubs can afford to provide their own helmets along with a custom colors and artwork, including information such as a the team's name, player's number, team logo, and team colors, many youth leagues do not have a sufficient budget to provide such custom equipment to players. In addition, often an individual playing lacrosse will purchase his or her own helmet and may want to customize the helmet so it will conform to a particular club team. Further, in many circumstances a player may participate on more than one team, such as a school team, a club team, or a select team. In such situations, a player is faced with the undesirable option of purchasing multiple helmets for each team that will conform to the team color. Since many of the seasons for such teams run concurrently painting or applying decals to the helmets for each team is not a practical solution.

As discussed above, providing a uniform helmet color and uniform team logo for all the players on a team is desirable because it allows players to more quickly identify players on his or her own team and distinguish players on the opposing team. Providing matching uniforms on a team can also build team unity, build player confidence, and may be somewhat intimidating to opponents. While it is desirable to have matching uniforms, in view of the costs of helmets many youth leagues simply elect to use a solid color and the solid color is typically white. However, this condition is not desirable because, inter alia it reduces the ability of players and coaches to differentiate players from one team from another.

It is therefore the objective of the invention to design a helmet cover that is suitable for a lacrosse helmet. It is further objective to provide a cover that is appropriate for use during game conditions and can be secured to the helmet by the player so that it will be maintained in place as the helmet is taken on and off the players head. The cover should accommodate the built in brim of a lacrosse helmet, closely conform to the shape of the complete exterior shell section of the helmet which has an exterior surface that is different than a football helmet. In addition, the helmet cover should minimize any overlap with the face opening to allow for maximum visibility and stay secured on the helmet during play. Finally the helmet cover, should cover substantially the entire exterior surface of the helmet so that it will have a fitted, smooth and continuous look.

### SUMMARY OF THE INVENTION

The present invention is directed to a lacrosse helmet cover that is designed to cover the exterior of the shell, including a region intended to protect the temporal region of the cranium opposite the ears. The invention includes providing four panel sections comprised of an elastic fabric that are assembled in a manner to allow the cover to conform to the unique shape of a lacrosse helmet.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 is a prior art football helmet cover.

FIG. 2 is another prior art football helmet cover

FIG. 3 is a further prior art football helmet cover

FIG. 4 is yet another prior art football helmet cover.

FIG. 5 is a perspective view of an embodiment of the invention.

FIG. 6 is a rear view in elevation of the embodiment depicted in FIG. 5.

FIG. 7 is a front view in elevation of the embodiment depicted in FIG. 5.

FIG. 8 is the middle panel used to construct the embodiment depicted in FIG. 5.

FIG. 9 is rear panel used to construct the embodiment depicted in FIG. 5.

FIG. 10 is the right lateral panel used to construct the embodiment depicted in FIG. 5.

FIG. 11 is the left lateral panel used to construct the embodiment depicted in FIG. 5.

FIG. 12 is a top view of the of the embodiment depicted in FIG. 5 in place on first conventional lacrosse helmet

FIG. 13 is bottom view of a first conventional lacrosse helmet.

FIG. 14 is a side view of the first conventional lacrosse helmet depicted in FIG. 13.

FIG. 15 is a side view of a second conventional lacrosse helmet.

FIG. 16 is a side view of cover depicted in FIG. 5 secured on the first conventional lacrosse helmet as depicted in FIG. 14.

FIG. 17 is a side view of the cover depicted in FIG. 5 secured on the second as depicted in FIG. 15.

### DETAILED DESCRIPTION

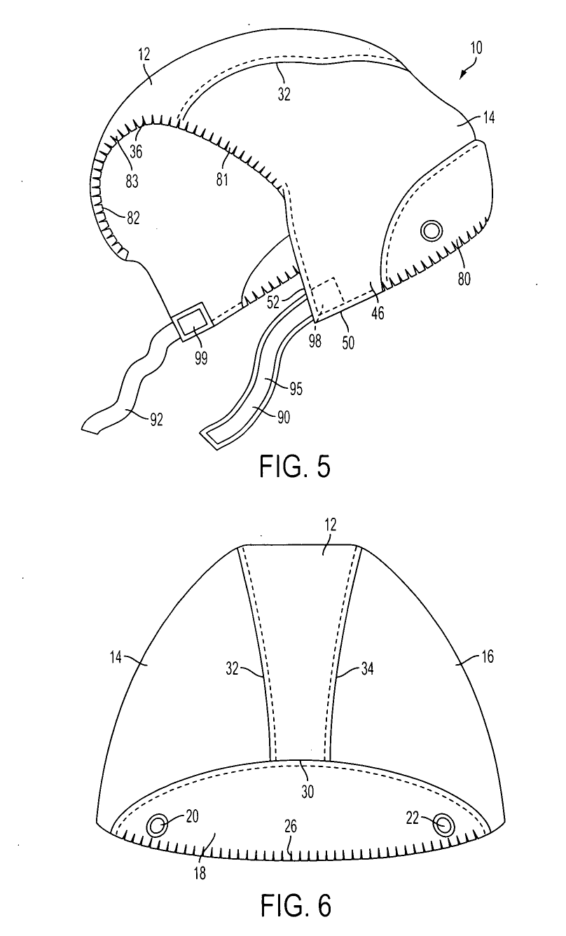

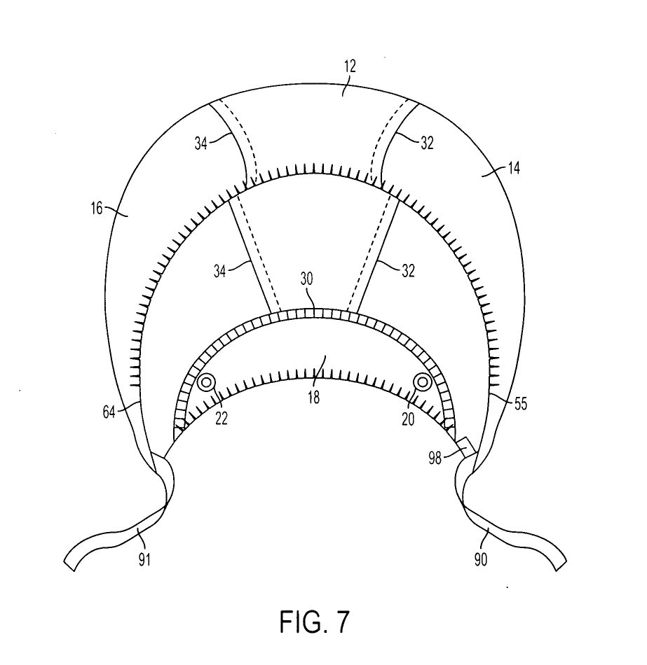

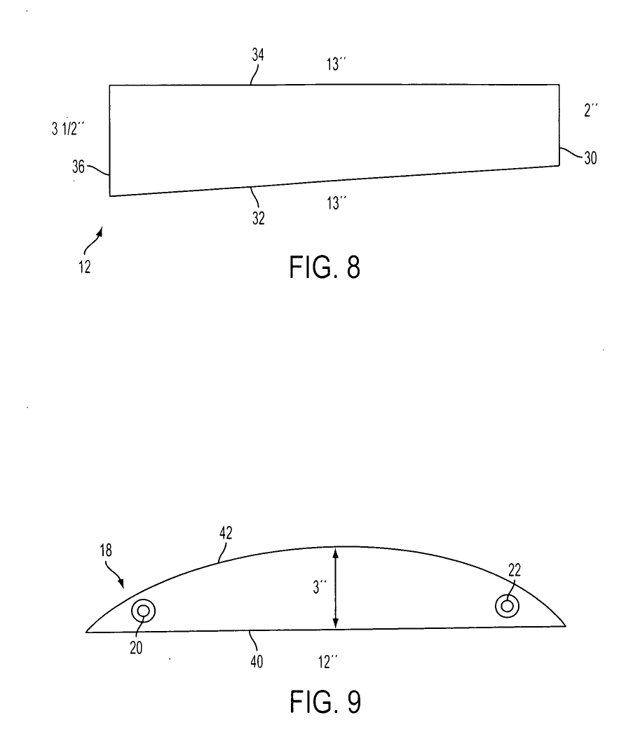

Now referring to FIG. 5, an embodiment of the helmet cover device 10 is made from an elastic fabric, preferably spandex, and which is constructed to cover the entire exterior shell of a helmet including the brim section above the facemask. In the embodiment, the material used for the cover is made from a 90% cotton/10% Lycra® spandex. As best seen in FIG. 5, the cover includes openings 20 and 22 to receive chinstrap hardware snap posts through the rear panel 18. The openings are reinforced.

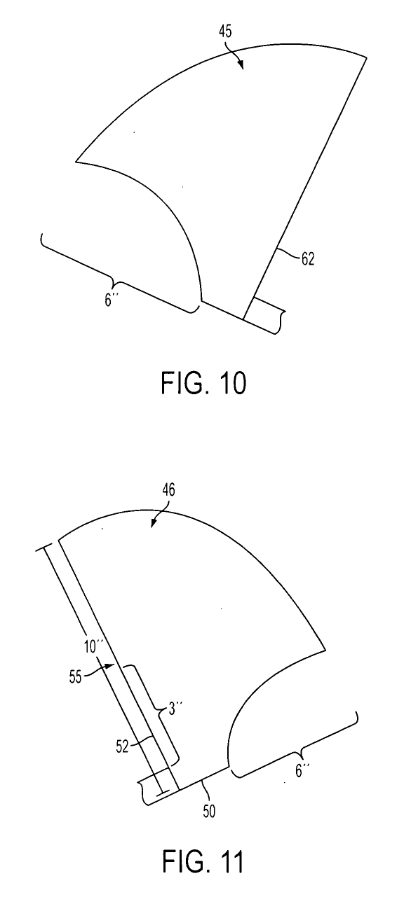

As best seen in FIG. 10, the device is constructed from four fabric panels including a center top fabric panel 12, two lateral sides 14 and 16, and a rear panel 18 that is generally crescent shaped. Rear panel 18 includes two circular openings 20 and 22 that are designed to receive the chinstrap hardware which will extend through the openings to allow access to the hardware. In an embodiment the center panel 12 is generally a polygon having a rear side 30 that has a dimension of about 2 inches; two lateral sides 32 and 34 each having the same dimension of approximately 13 inches; and a front side 36 that is approximately and 3½ inches longer than the rear side. When assembled, the front side 30 is gathered together and has a dimension of approximately 1¾ inches when in a relaxed position. Now referring to FIG. 9, the rear panel 18 has a straight side 40 that a length of approximately 12 inches and a curved or arc side 42. The maximum width at the center of the part is approximately 3 inches. When the device is assembled, the side 40 or rear panel is gathered and bound to an elastic band and has a length of approximately 7 inches when in a relaxed position. When the fabric is stretched and fitted to a helmet, it can extend to its full length of approximately 12 inches. An elastic band is sewn around the periphery of the device. Referring now to FIGS. 10 and 11, the lateral panels 45 and 46 have a unique shape. Panel 46 is defined by bottom side 50 which has a dimension of approximately 1½ A inches. Adjacent to the bottom side 50 and extending upwards at a right angle is lateral side 52 which defines a portion of the opening for the face. Lateral side 52 is approximately 10 inches when in a relaxed position. Approximately 3 inches from the location that the lateral side 52 intersects with the bottom side 50, identified as location 55, the fabric is gathered together with an elastic band, in a procedure referred to as shining, when the device is assembled. This construction allows for flexibility of the cover around the brim and facemask, and along the rear panel section.

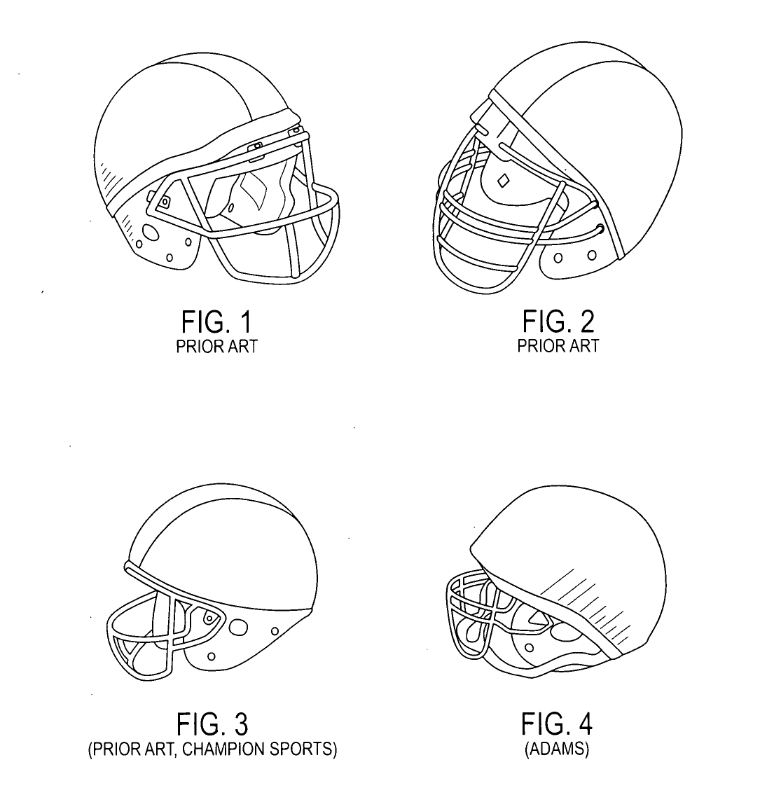

Referring back to FIG. 1, the panels are stitched or sewn together, preferably using an elastic thread, and an elastic band is inserted around the periphery of the device, which includes front side 52 of the lateral panel, the central panel and the front side 54 of lateral panel 14. The fabric is also gathered together along the edge 82 of the rear panel. The gathering of fabric together in the rear panel 80 and along the front opening at locations 81, 82 and 83 that defines the face mask opening allows the fabric to be stretched to accommodate a wide variety of commercially available lacrosse helmets.

Straps 90 and 92 are provided on opposite sides that extend from and are designed to be secured to the chin guard of a conventional lacrosse helmet. The straps are made from a synthetic fiber such as nylon and incorporate a hook and loop fastening system to provide for releasable engagement with the helmet.

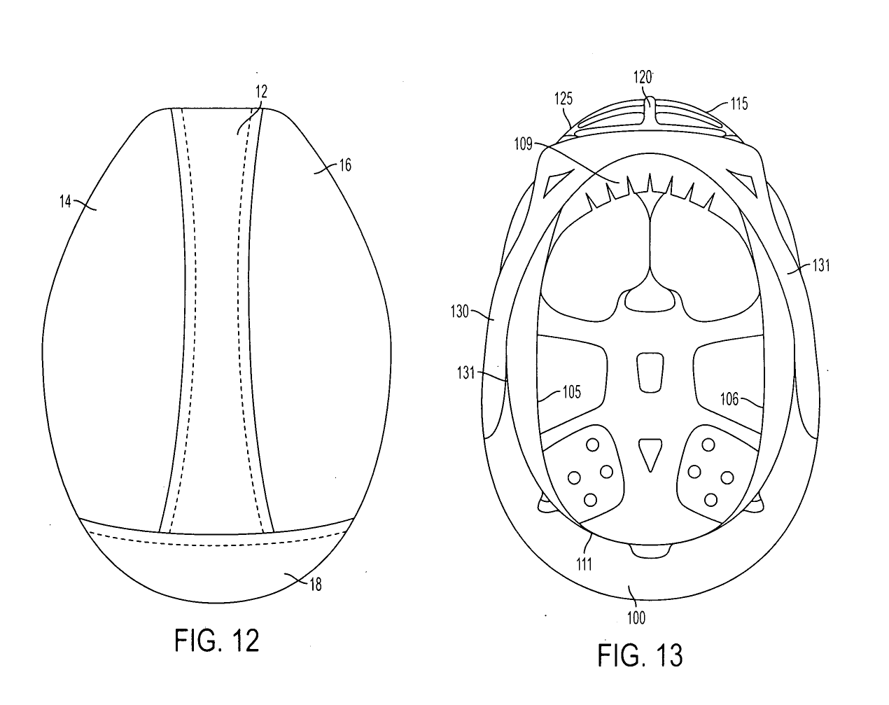

Now referring to FIG. 12, the device is depicted after it has been stretched to cover a first conventional lacrosse helmet. The structure is characterized by a substantially smooth outer covering which covers the brim and uses the protruding structure of the brim to hold the fabric.

Now referring to FIG. 13, a lacrosse helmet includes an outer shell 100 made from high density polyethylene, a liner system including lateral pads 105 and 106 to engage the player's temples and front pads 109 to engage the forehead, a face mask 115 with both vertical oriented bars 120 and horizontal oriented bars 125, a low profile chin guard extension 130 that extends from a location on the lateral side of the helmet and generally conforms to the shape of the lower mandible, and a short brim visor. The helmet shape, including the face mask, when viewed from above is generally the shape of an ellipse or ellipsoid.

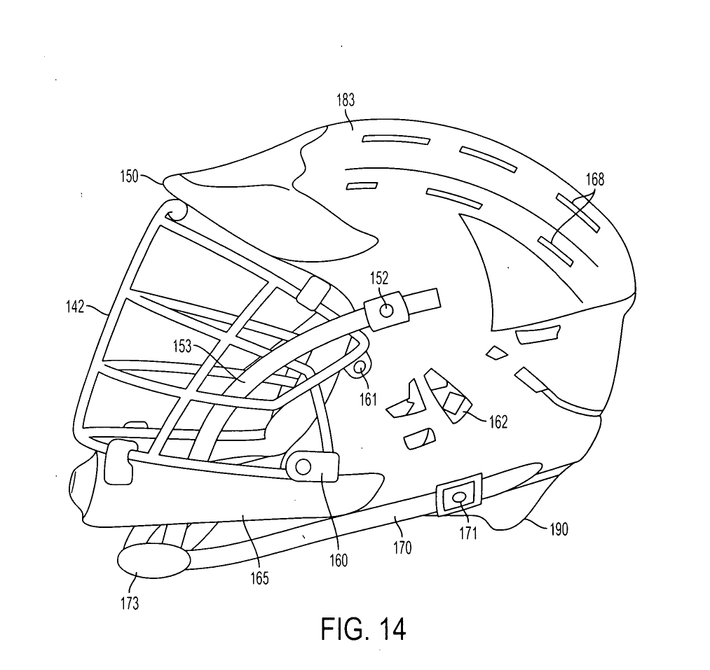

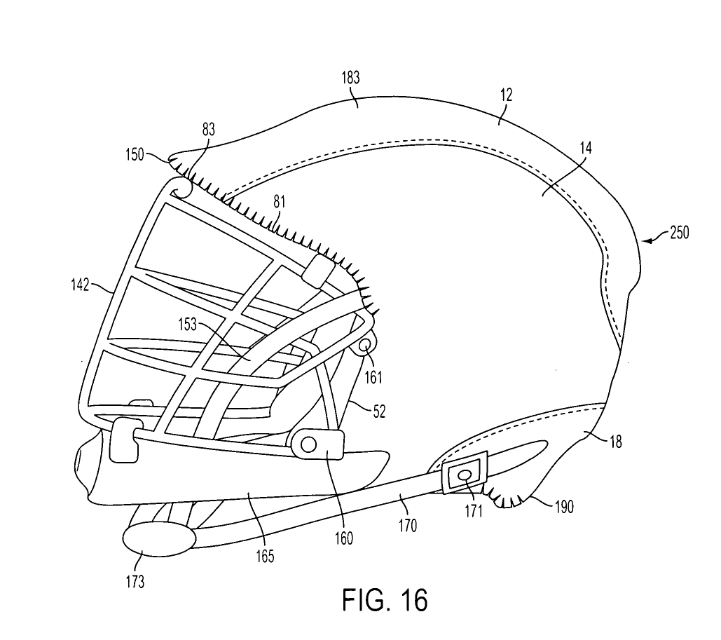

Now referring to FIG. 14, in use, the player will first secure the forward chin straps, such as strap 153, to the hardware snap posts located at position 152 on the front of the helmet. Strap 170 is depicted attached to the rear post location 170 on one end and the chin cup 173 on the opposite end. Chin cup 173 is shaped to receive the players chin. The chinstrap depicted generally is maintained in place as the helmet is put on and removed by the attachment to the front snap posts at location 152. The helmet includes exterior shell 183, which includes rear lip 190, vents 168, ear opening 162, face mask 142 and chin guard 165. When the cover is installed, the front lateral edge 83 of the center panel 36, and front edges 81 and 82 of side panels 14 and 16 is tucked under the brim 150 above the face mask 142 and extend along the side of the face mask 142. The helmet cover is then stretched over the brim of the helmet and pulled toward the rear of the helmet to engage the lip 190 at the rear edge. Next the straps 91 and 92 are pulled forwardly and downwardly to cause the edges 82 and 81 to abut the face mask attachment hardware 160 and 161. The straps are wrapped around chin guard 165 and secured by engagement of the loops on surfaces 95 of the straps to the hooks 98 and 99 provided on the inside surface of the cover. The straps are fastened to the helmet by wrapping the straps around the chin guard and looping the fabric back upon itself. As discussed above, in embodiments, the straps are provided with a fabric hook and loop fastening system, such as Velcro®, wherein the hooks are sewn to the inside surface of the cover. As best seen in FIG. 13, the rear edge 26 of rear panel 18 is stretched over lip edge 111 to retain the cover in place. As shown in FIG. 16, after the cover 250 is secured in place on the helmet depicted in FIG. 14, the cover resembles a substantially smooth continuous covering that closely conform to the shell and brim of the helmet.

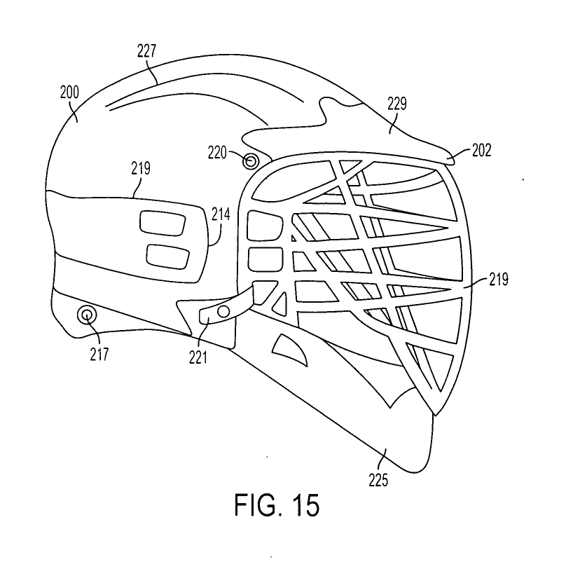

Referring now to FIG. 15, an alternative model lacrosse helmet is depicted including the exterior shell 200, the forward brim 229 having brim extension 202, face mask 219 and chin guard 225. The helmet is designed to receive a four point shin strap, not shown, by the engagement of snap hardware post 220 and 217. The facemask is secured to the lateral sides of the helmet by fastener 221. The top of the facemask 219 is secured at the top center of the mask to the helmet under the brim extension 202 and is not visible. The helmet has an irregular exterior surface as reflected by ridges structures 227 and ridge structure 214 and ridge structure 219.

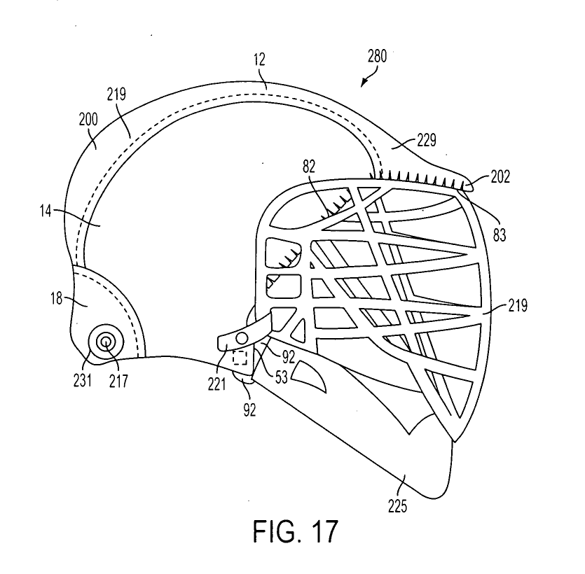

As shown in FIG. 17, after the cover 280 is secured in place on the helmet depicted in FIG. 15, the cover resembles a substantially smooth continuous covering that closely conform to the shell and brim of the helmet. An opening 281 is provided to allow access to the rear chinstrap posts 217. The forward posts such as post 220, are not visible because they are under the cover.

Those skilled in the art will appreciate that the coverings and sports helmets of the present invention, overcome many disadvantages with sports helmets of the prior art while maintaining a relatively low expense, such as: (a) affording individuals, teams, clubs, and other organizations an opportunity to customize their helmets with the team's name, player's name, player's number, team logo, or team colors; this is especially true in youth leagues but applies to any organization or individual; (b) allowing individual players to decorate their helmets with stickers, paint, and/or markers to personalize the helmet and/or show their accomplishments (and may be packaged together with such stickers); and (c) providing an extra degree of protection to prevent damage, wear and tear, and cosmetic blemishes to the helmets.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. An improved cover for a lacrosse helmet comprising four fabric panels, said fabric comprising said panels including a first center panel formed from said fabric cut into the shape of a polygon, a rear panel cut fro said fabric in the shape of a circle segment defined by a chord, and two lateral side panels cut from fabric, wherein said lateral, said cover further comprising opening in said rear panel for receiving helmet hardware, and wherein said segment are sewn together and the fabric is gathered along the chord of said read panel, a portion of the lateral sides of the lateral side sections, and the front side of the center polygon section.

2. The device as recited in claim 1 further comprising elongate straps that extend from said lateral side panels and which are adapted to be secured to a chin guard.

3. The device as recited in claim 3 wherein said straps further comprise a fabric hook and loop fastening system.

4. A lacrosse helmet and cover combination comprising, a lacrosse helmet, said helmet comprising a polyurethane shell section, said shell section having a bottom opening to receive a player's head, and a lateral opening that generally frames a player's face, wherein said bottom opening and side opening are contiguous, a liner provided within and mechanically attached to the shell section, said liner including a resilient padding, a chin guard, a face mask attached to the lateral sides of said lateral opening, and an abbreviated brim located above the lateral opening and extend a distance to cover the top of the face mask, and cover comprising and elastic fabric made from a plurality of panels, said cover having a lateral opening and a bottom opening, contiguous with each other and roughly defining intersecting planes, wherein said intersection is approximately an angle of 90 degrees, and wherein each opening is generally in the shape of the segment of a circle, and wherein the fabric is gathered together along a portion of the edges that define the openings.

5. The device as recited in claim 4 further comprising elongate straps that extend from said lateral side panels and which are adapted to be secured to a chin guard.

6. The device as recited in claim 4 wherein said straps further comprise a fabric hook and loop fastening system.

7. The device recited in claim 4 further comprising openings provided adjacent to the rear opening edge sized to receive lacrosse helmet snap post hardware.
